(19) United States
(12) Patent Application Publication
(10) Pub. No.: US 2021/0078369 A1
(43) Pub. Date: Mar. 18, 2021

(54) PNEUMATIC TYRE COMPRISING A FOAM MATERIAL FOR SOUND ABSORPTION

(71) Applicant: BRIDGESTONE CORPORATION, Tokyo (JP)

(72) Inventors: Pasquale AGORETTI, Roma (IT); Barbara Maria SECCHI, Roma (IT); Claudio D'ALFONSO, Roma (IT); Giampiero PAVONI, Roma (IT)

(73) Assignee: BRIDGESTONE CORPORATION, Tokyo (JP)

(21) Appl. No.: 16/611,901

(22) PCT Filed: May 9, 2018
(86) PCT No.: PCT/EP2018/061956

§ 371 Date: Nov. 8, 2019

(30) Foreign Application Priority Data
May 10, 2017 (IT) 102017000050662

(51) Int. Cl. B60C 19/00; B60C 1/00; C08L 75/04

(52) U.S. Cl. CPC B60C 19/002; C08L 75/04; B60C 1/00

(57) ABSTRACT

A pneumatic tyre comprising an impermeable layer that is suitable for guaranteeing the pressure tightness of the air contained within the internal cavity of the casing and a layer of sound-insulating material housed within said internal cavity and made, in turn, with polyols deriving from CNSL.

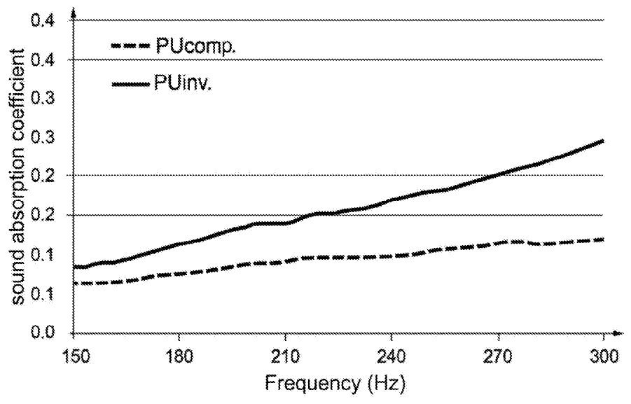

The object of the present invention relates to a pneumatic tyre comprising a foam material used for sound absorption. The foam material used in the present invention is made with compounds from renewable sources.

As shall be illustrated in the following description, the foam material utilized in the present invention, other than guaranteeing an improvement in terms of sound absorption and water absorption, also has an advantage of an environmental character.

One of the noises produced by an operating pneumatic tyre relates to the resonant cavity sound generated by vibrations of the pressurized air present within the internal cavity. As is known, the internal cavity of a pneumatic tyre is coated with an impermeable layer and is filled with pressurized air.

For the abatement of this type of noise, the usage has long been known of a porous material applied to the surface of the impermeable layer of the internal cavity. In particular, the resonant cavity sound that is mostly observed within a vehicle is characterized by sound waves of a relatively low frequency, in particular in the range between 180 and 300 Hz.

The foam material most commonly utilized for this purpose is polyurethane foam. The polyurethane foam that is utilized as a sound-insulating material in pneumatic tyres is currently made with materials deriving from fossil resources, such as oil.

WO2013182477 discloses a tyre comprising a layer of acoustic absorption material housed on the inside inner cavity. The acoustic absorption material is polyurethane foam made of polyether or polyester polyols.

EP1930355 discloses polyether polyols which are prepared by alkoxylation of renewable resource materials, and particularly cashew nutshell liquid (CNSL), and to a process for the preparation of these novel polyether polyols.

Although this type of polyurethane foam has satisfactory properties in terms of sound absorption, the need was however felt for a material that would provide better performance in terms of both sound absorption and water absorption.

A sound-insulating layer made with a polyurethane foam with low water absorption, will be less subject to an increase in weight over time, with the subsequent advantages in terms of rolling resistance and vehicle consumptions that this results in. For a correct assessment of such a characteristic it is to be considered that within the internal cavity of the pneumatic tyre, it is necessary for the sound-insulating material to be in contact with the water vapor present within the pressurized air.

Furthermore, the ever increasingly limited availability of fossil resources and the environmental problems deriving from the excessive use of combustible fossils, has also brought about the need to find a sound-insulating material for pneumatic tyres that, other than resulting in advantages in terms of sound absorption and water absorption, may also have a lower environmental impact.

The Applicant has surprisingly found that the polyurethane foam made with the polyols contained with the oil deriving from the processing of cashew nut shells (hereinafter indicated with the commonly utilized English acronym CNSL—Cashew Nut Shell Liquid), does not only guarantee a lower environmental impact, but at the same time, it has, in an unexpected manner, better characteristics in terms of sound absorption and water absorption, and also better aging stability.

The object of the present invention is a pneumatic tyre comprising an impermeable layer that is suitable for guaranteeing the pressure tightness of the air contained within the internal cavity of the casing and a layer of sound-insulating material housed within said internal cavity; said pneumatic tyre being characterized by the fact that said sound-insulating material is a polyurethane foam made with polyols deriving from CNSL.

The polyurethane foam made with polyols deriving from CNSL comprises from 25 to 45% by weight of components emanating from renewable sources.

Preferably, said polyurethane foam has an apparent density of between 5 and 100 kg/m³ (between 5 and 100 g/dm³), more preferably between 10 and 30 kg/m³ (between 10 and 30 g/dm³).

Preferably, the layer of foam material occupies a volume of between 0.1 and 100% of the volume of the internal cavity. More preferably, the layer of foam material has a thickness of between 10 and 200 mm and a width of between 10 and 100% of the width of the internal cavity.

Preferably, the layer of foam material occupies a volume of between 0.4 and 20% of the volume of the internal cavity. More preferably, the layer of foam material has a thickness of between 20 and 30 mm and a width of between 20 and 40% of the width of the internal cavity.

Preferably, the layer of foam material is housed on the internal surface of the impermeable layer of the internal cavity of the pneumatic tyre.

Preferably, the layer of foam material can be housed within the cavity in the form of a toroid, or else in the form of a strip of a length equal to that of the impermeable layer, or else in the form of single segments assembled in such a way that it covers the entire length of the impermeable layer.

A further object of the present invention is the use of a polyurethane made with polyols deriving from CNSL as a sound-insulating material inserted in the cavities of pneumatic tyres.

Reported below are examples of non-limiting embodiments given purely by way of illustration with the aid of the attached FIGURE, which is a graph relating to a comparison between the sound absorption of the polyurethane foam which is commonly of fossil origin and the polyurethane foam utilized in the present invention.

Reported below, in terms of sound absorption and water absorption, is a comparison between a polyurethane foam that is commonly used as a sound-insulating material in pneumatic tyres (PU-comp.) and deriving from fossil resources, and a polyurethane foam obtained using polyols deriving from CNSL (PU-inv.) according to the present invention.

The polyurethane foam of the prior art utilized for comparison, is marketed under the trade name Metzonor 023 and is produced by Metzler Schaum GMBH.

The polyurethane foam utilized in this invention is made according to example 3 reported within the patent application EP1930355A2.

The polyurethane foam used for comparison (PU-comp.) and the polyurethane foam used as an example for the present invention (PU-inv.) have the same apparent density.

Reported in the FIGURE is the sound absorption coefficient of both of the polyurethanes described above as a function of frequency. From the FIGURE, within the frequency range that characterizes the noise observed within the vehicle, it can clearly be seen that the polyurethane made with the polyols deriving from CNSL has a sound absorption coefficient that is progressively greater than that of the comparison polyurethane.

The sound absorption test was performed according to the ISO 10534-2 standard at a frequency of between 180 and 300 Hz.

The water absorption test was performed by measuring the variation in weight of the polyurethane foam after the same was exposed to air at a controlled temperature and humidity for a period of 7 days and, successively, after the same had been maintained within a vacuum oven at 70° C. for a period of 24 hours. The water absorption index is expressed as a variation in weight which is normalized in relation to the dry weight of the foam (the lower the index, the lower the water absorption.)

The results of the above tests are reported in Table I in indexed form with respect to the respective results obtained with the comparison polyurethane foam (PU-comp.).

For a correct assessment of the results reported in Table I, it should be specified that the greater the relevant absorption coefficient and the lower the water absorption index the better the sound-insulating material.

TABLE I

| | PU-comp. | Pu-inv. |
|---|---|---|
| Sound absorption | 100 | 150 |
| Water Absorption | 100 | 60 |

From the values reported in Table I it is evident that the polyurethane foam used in the present invention guarantees, in relation to the polyurethane foam of the prior art, both a greater sound absorption coefficient and a lower water absorption index.

To summarize, the polyurethane foam utilized according to the present invention does not only offer the great advantage of being made with material emanating from a renewable source but, at the same, it guarantees, in relation to polyurethane foam of fossil origin and indeed of the prior art, advantages in terms of sound absorption and water absorption.

Finally, it is the opinion of the inventors that the polyurethane foam according to the invention, by virtue of the low water absorption and the differing chemical composition, is able to guarantee greater aging stability in relation to the polyurethane foam of the prior art.

1. Pneumatic tyre comprising an impermeable layer that is suitable for guaranteeing the pressure tightness of the air contained within the internal cavity of the casing and a layer of sound-insulating material housed within said internal cavity; said pneumatic tyre being characterized in that said sound-insulating material is a polyurethane foam made with polyols deriving from CNSL.

2. Pneumatic tyre according to claim 1, characterized in that said polyurethane foam has an apparent density of between 5 and 100 kg/m³ (between 5 and 100 g/dm³).

3. Pneumatic tyre according to claim 1, characterized in that said polyurethane foam has an apparent density of between 10 and 30 kg/m³ (between 10 and 30 g/dm³).

4. Pneumatic tyre according to claim 1, characterized in that the layer of sound-insulating material occupies a volume of between 0.1 and 100% of the volume of the internal cavity.

5. Use of a polyurethane foam made with polyols deriving from CNSL as a sound-insulating material housed within the cavity of a pneumatic tyre.

6. Use according to claim 5, characterized in that said polyurethane foam has an apparent density of between 5 and 100 kg/m³ (between 5 and 100 g/dm³).

7. Use according to claim 5, characterized in that said polyurethane foam has an apparent density of between 10 and 30 kg/m³ (between 10 and 30 g/dm³).
